(19) United States
(12) Patent Application Publication
(10) Pub. No.: US 2003/0153356 A1
(43) Pub. Date: Aug. 14, 2003

(54) Mobile phone for multiple SIM cards

(76) Inventor: Shih-Yuan Liu, Shin-Tien City (TW)

Correspondence Address: BRUCE H. TROXELL, SUITE 1404, 5205 LEESBURG PIKE, FALLS CHURCH, VA, 22041, US

(21) Appl. No.: 10/055,933

(22) Filed: Jan. 28, 2002

(51) Int. Cl. H04B 1/38

(52) U.S. Cl. 455/558; 455/575; 455/347; 455/348; 455/418; 455/556; 455/557

(57) ABSTRACT

A mobile phone for multiple SIM cards, wherein, a telephonic apparatus is used to select by switching among a plurality of communication services provided by various providers in the art of system communication. The mobile phone is provided on the rear casing of the battery or between the main machine and the battery of the mobile phone with an electric circuit board having a plurality of SIM cards each is able to connect via a bus line with an extension card functioning as a communication interface of the mobile phone with the electric circuit board and parallelly connected with each of the SIM cards on the electric circuit board to thereby form an open loop. A manually moved switch is provided on the loop, so that when the switch is switched to the card loop of any system, the state of combination of the mobile phone is communicated with the card loop of this system. Therefore, an object of providing a plurality of SIM cards for a mobile phone can be attained.

### BACKGROUND OF THE INVENTION

1. Field of the Invention

The present invention is related to a mobile phone for multiple SIM cards, and especially to a mobile phone provided on the rear casing of the battery or between the main machine and the battery of the mobile phone with an electric circuit board having a plurality of SIM cards each is able to connect with an extension card functioning as a communication interface of the mobile phone with the electric circuit board, thereby, an object of providing a plurality of SIM cards for a mobile phone can be attained.

2. Description of the Prior Art

A conventional mobile phone uses a subscriber identification module (SIM card) provided by a provider in the art of system communication as an interface between itself and a base station for communication; each phone is only given a single SIM card which can not be reproduced. However, mobile phones have given unlimited commercial chances in their convenience in communication, many people in the art of system communication compete with one another for these chances, they provide a lot of projects such as various modes of fee calculation, and more peripheral services such as wireless networking, international roaming etc. in order to win more subscribers. Therefore, consumers can have more choices, and are stimulated to try to own two or even more communication systems. By virtue that expenditure for communication fees can be lowered by preferential modes of fee calculation provided by various systems, such modes can be available in more countries having roaming communication when going abroad, and such communication can compensate inferior quality of communication provided by different systems, hence owning services of two or even more communication systems is advantageous. Nevertheless, as stated above, each mobile phone is only given a subscriber number by a provider in the art of system communication, one who needs two or more numbers of subscriber must purchase two or more mobile phones. This not only makes a consumer pay for another kind of expense, but also inconvenient by carrying two or more mobile phones for use.

Those wise manufacturers of mobile phones developed mobile phones of which each can have selections of two different systems for communication in order to satisfy what customers require and for the sake of saving money for the customers. Wherein, in addition to that for the original system, a SIM card for a second system is added to a battery, and a digital logic IC designed for the device is used to select and switch for using the second different communication system to get an object of using two cards on a mobile phone.

With such progressing, however, as is well known, the mobile phones used and seen frequently in the markets presently are limited to certain brands, due to lack of principal techniques and some problems of patent right, these manufacturers of mobile phones own the most parts of the markets, thereby, prices of mobile phones can hardly be changed in the markets. Especially when the above stated function of “using two cards on a mobile phone” is added, the prices are even raised to be higher and higher.

The function of “using two cards on a mobile phone” provided by adding a SIM card to a battery, in addition to the above stated, has the following defects in manufacturing and use:

1. Such products are made through processing on batteries, their functions for use are generated by semiconductor logic IC's, thereby, cost of production thereof must be increased more.

2. The spaces utilizable of the batteries are originally not large, each of them can only be available for two cards on one mobile phone, and is difficult to be spread for such a larger scope as being available for multiple cards for one mobile phone.

3. Selection and switching of twin card systems are all driven by software in IC's, this is subjected to resulting problems of rejection or compatibility with other set software in their corresponding mobile phones.

4. Users must remember well the methods for switching among systems (generally switching is done via the keys on a mobile phone), in order not to be unable to use such functions.

5. The SIM cards are installed on the batteries, while the batteries have certain periods of utilization, when they are damaged and out of work, the function of such a mobile phone with two cards will elapse accordingly, this makes waste.

### SUMMARY OF THE INVENTION

In view of the above inconvenience and defects in mounting or use of the above stated practices, the object of the present invention is to provide a mobile phone for multiple SIM cards, it is provided on the rear casing of the battery or between the main machine and the battery of the mobile phone with an electric circuit board having a plurality of SIM cards, the electric circuit board is further provided on the loop thereof with an extension card connected with a bus line. The extension card functions as a communication interface of the mobile phone with the electric circuit board, and is parallelly connected with each of a plurality of SIM cards on the electric circuit board to thereby form an open loop. A manually moved switch is provided on the loop, so that when the switch is switched to the card loop of any system, the state of combination of the mobile phone now is communicated with the card loop of this system. Therefore, an object of providing a plurality of SIM cards for a mobile phone can be attained; wherein, the manually moved switch is directly manipulated to select a desired communication system. Such a structure and its mode of operation will have the following convenience and advantages:

1. The machine can have its cost of assembling and production certainly lower than the former practices by processing on the rear casing of the battery. It can have the same price as that of the conventional mobile phone with the same function, hence the price will not completely be controlled by big manufacturers, and thereby can be more reasonable.

2. A plurality of SIM cards belonging to various systems are mounted on the rear casing of the battery which has a very large available space, the space can even be enlarged by increasing the receiving capacity of the rear casing (which is made of plastic and thereby has large elasticity) to be loaded with even more SIM cards without limitation by the specifications of various brands of manufacturers. Thereby, the functions of the present invention can be extremely developed.

3. The present invention utilizes a simple electronic loop plus a manually moved switch for systematic switching and selection, it is most inexpensive as to the cost of hardware, and does not need any expensive IC control and driving of software, communication among mobile phones is totally mutually compatible without impediment.

4. Accordingly, the present invention provides a mobile phone for multiple SIM cards utilizing a simplest manually moved switch for systematic switching and selection; a user does not need to forcedly remember complicated switching ways, and thereby, operation can be most simplified.

5. A plurality of SIM cards are received in the rear casing of the battery, thereby, the function of use of the mobile phone will totally not influenced even when the battery is damaged in consuming.

6. The present invention can also suit those mobile phones without any rear casing.

The present invention will be apparent in its detailed structure and modes of operation after reading the detailed description of the preferred embodiment thereof in reference to the accompanying drawings.

### BRIEF DESCRIPTION OF THE DRAWINGS

FIG. 1 is a perspective view showing the appearance of a mobile phone of a preferred embodiment of the present invention;

FIG. 2 is a perspective view showing the structure of a rear casing of the mobile phone of FIG. 1;

FIG. 3 is a plane view showing the structure of an electric circuit board of the mobile phone of FIG. 1 with multiple cards;

FIG. 4 is a side view of FIG. 3;

FIG. 5 is a rear side view of FIG. 3;

FIG. 6 is a plane view showing the structure of another preferred embodiment of electric circuit board of the mobile phone of the present invention with multiple cards;

FIG. 7 is a side view of FIG. 6;

FIG. 8 is a rear side view of FIG. 6;

FIG. 9 is a plane view showing the structure of another preferred embodiment of electric circuit board of the mobile phone of the present invention with multiple cards;

FIG. 10 is a side view of FIG. 9;

FIG. 11 is a rear side view of FIG. 9;

FIG. 12 is a plane view showing the structure of another preferred embodiment of electric circuit board of the mobile phone of the present invention with multiple cards;

FIG. 13 is a side view of FIG. 12;

FIG. 14 is a rear side view of FIG. 12;

FIG. 15 is a circuit diagram showing the state of combination of the electric circuit of the present invention;

FIG. 16 is an analytic perspective view showing a mobile phone of another preferred embodiment of the present invention provided with a rear casing;

FIG. 17 is a perspective view showing the appearance of an interface card of the mobile phone of FIG. 16;

FIG. 18 is a rear side view of the interface card of FIG. 16;

FIG. 19 is a partially enlarged diagram showing a locking mechanism designed for the mobile phone for positioning the interface card of FIG. 16;

FIG. 20 is a partially enlarged diagram showing the action of the locking mechanism of FIG. 19;

FIG. 21 is a schematic view showing the sliding action for positioning of the interface card of FIG. 16 in the mobile phone by means of grooves and rails;

FIG. 22 is a schematic view showing subsequent actions of the interface card of FIG. 21;

FIG. 23 is a schematic view showing subsequent actions of the interface card of FIG. 22; wherein, the interface card has been completely positioned in the mobile phone.

### DETAILED DESCRIPTION OF THE PREFERRED EMBODIMENT

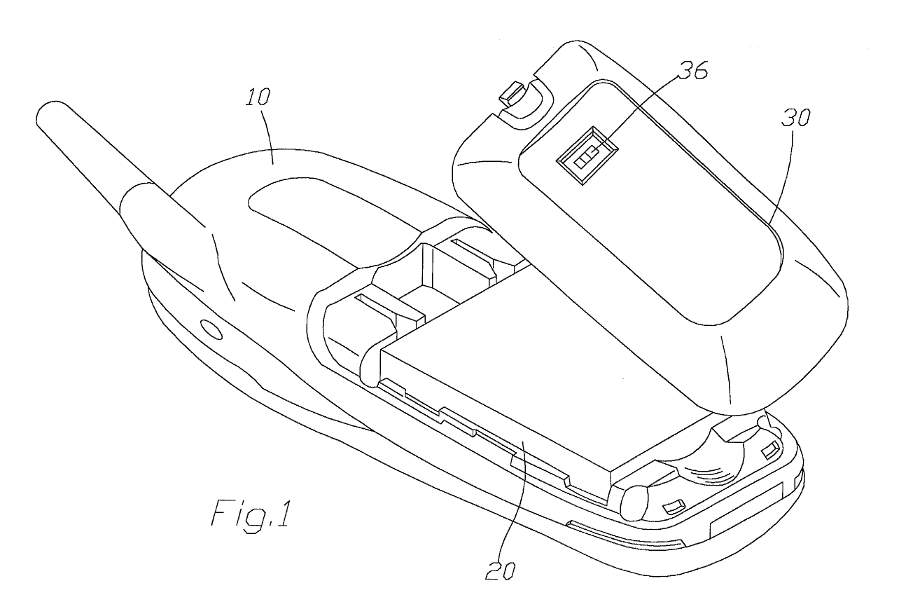

Referring to FIG. 1, the preferred embodiment of the present invention is comprised at least of a telephonic apparatus 10, a battery 20, and a rear casing 30 for covering the battery 20 and connecting with the telephonic apparatus 10. The rear casing 30 is provided thereon with an engaging member in cooperating with the telephonic apparatus 10.

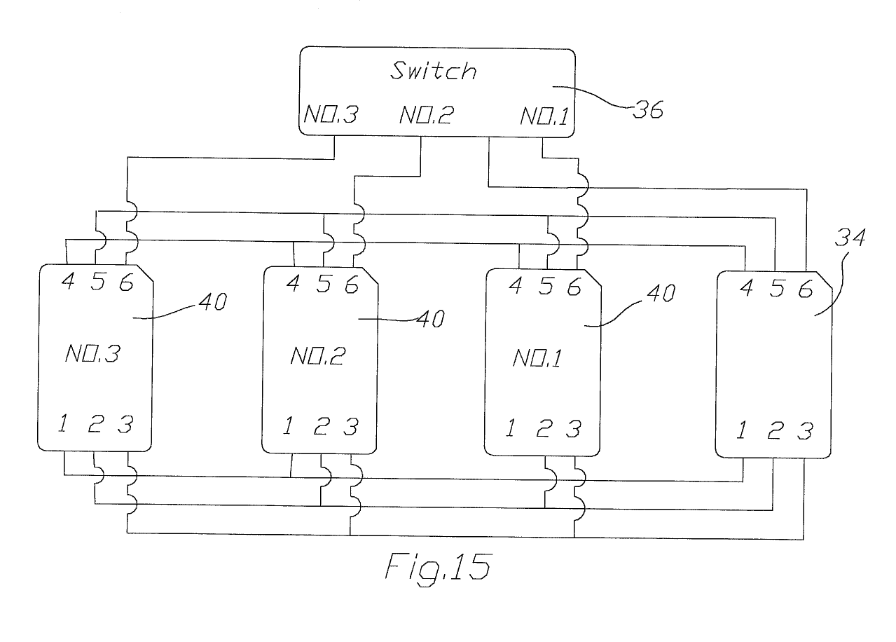

As shown in FIG. 2, it shows the contrary side of the rear casing 30 for the battery 20. The rear casing 30 has certain receiving capacity at least for loading of an electric circuit board 31 which is positioned in the rear casing 30 with a plurality of fixing screws. The electric circuit board 31 has a plurality of connectors 32 used for SIM cards 40 provided by providers in the art of system communication. Each SIM card 40 representing one of the various systems (or the same system) forms a parallelly connected loop connected through a connecting point provided on the electric circuit board 31 as shown in FIG. 15. Additionally, the electric circuit board 31 has thereon a soft bus line 33 to connect an extension card 34 which is inserted in the position where the SIM cards 40 are originally located in the telephonic apparatus 10 (not shown), so that the communication loop of the telephonic apparatus 10 can be communicated with the electric circuit board 31 in the rear casing 30 by means of the extension card 34 as an interface, and thereby, each SIM card 40 can have its function developed.

The most important thing is, the electric circuit board 31 is installed thereon a manually moved switch 36 on the contrary side to that loaded with the SIM cards 40. The manually moved switch 36 is exposed to the outside of the rear casing 30 for manually moving, and is connected to form a loop with the circuit of the electric circuit board 31. As shown in FIG. 15, when the manually moved switch 36 is switched to the loop of a SIM card 40 of any system, the state of combination of the telephonic apparatus 10 now is communicated in the close state with the card loop of this system. Therefore, an object of providing a plurality of SIM cards for a mobile phone can be attained.

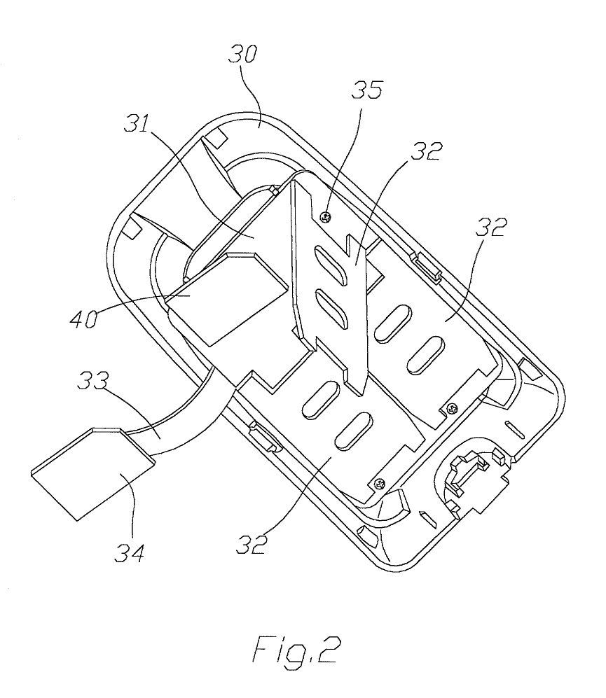

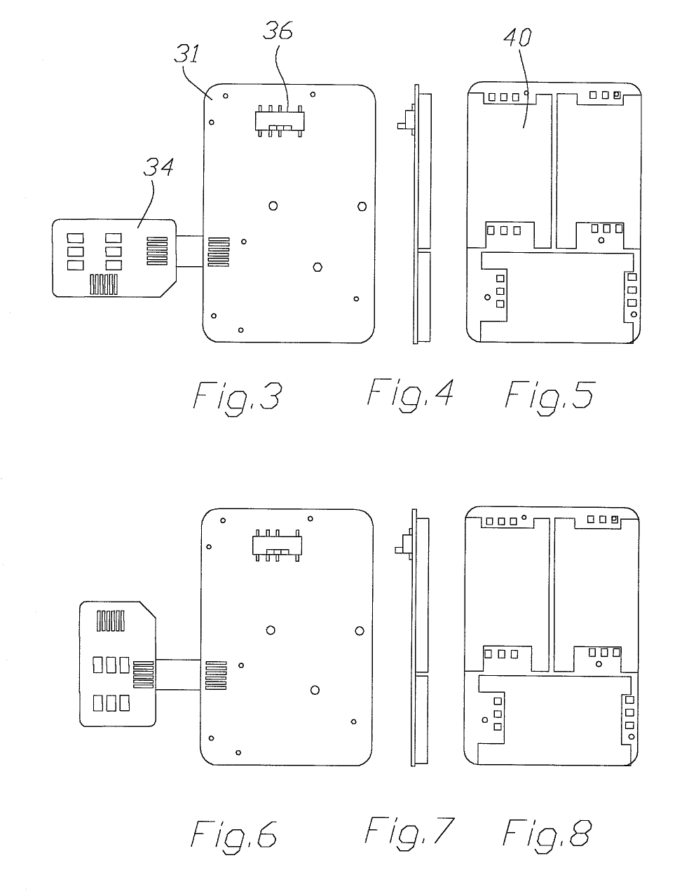

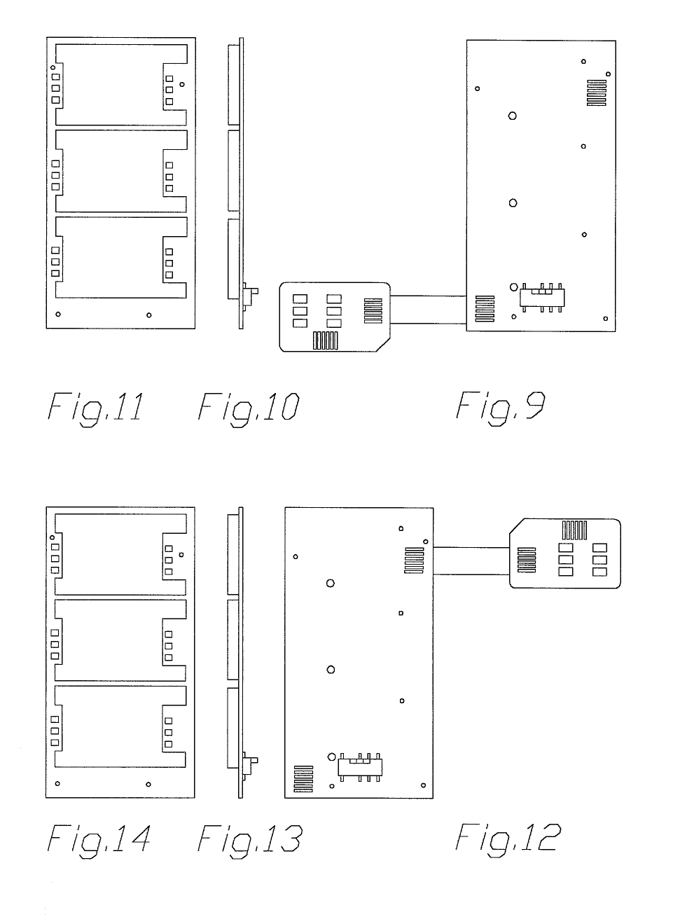

As shown in FIGS. 3-5 which are plane views showing the structure of the electric circuit board 31 connecting with an extension card 34. It can be seen from these drawings that, a plurality of SIM cards 40 can be adjusted and allocated in pursuance of the real requirement or the area of the electric circuit board 31. And as shown in FIGS. 6-8, the extension card 34 can also be adjusted for its orientation as well as position according to the requirement of the brand of telephonic apparatus 10, in this mode, the present invention can be available for a larger scope. And as shown in FIGS. 9-14, they are depicted here to show the structures of other two SIM cards 40.

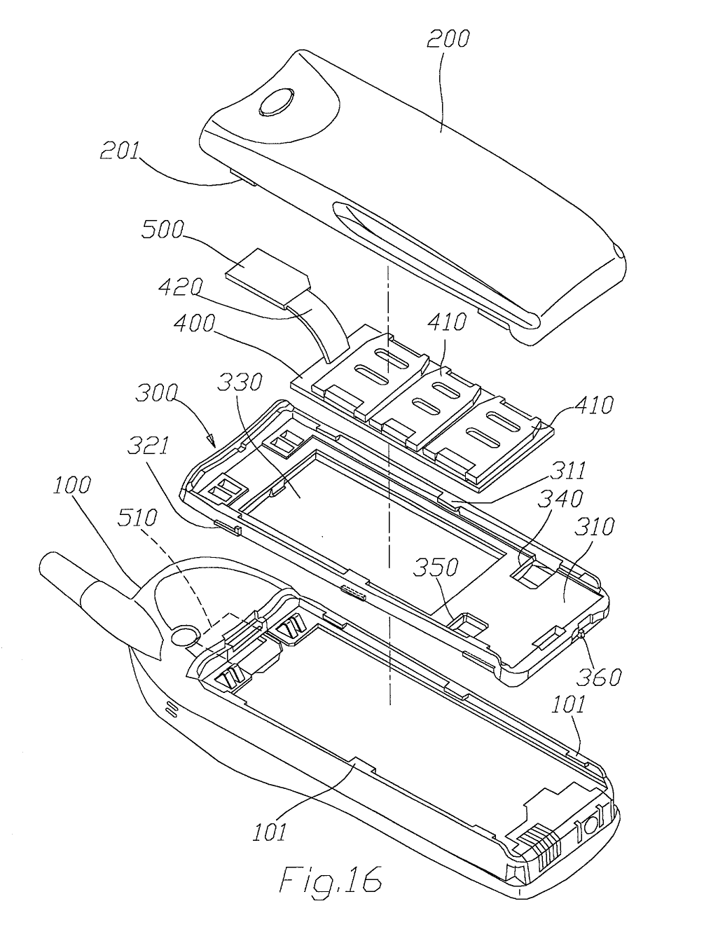

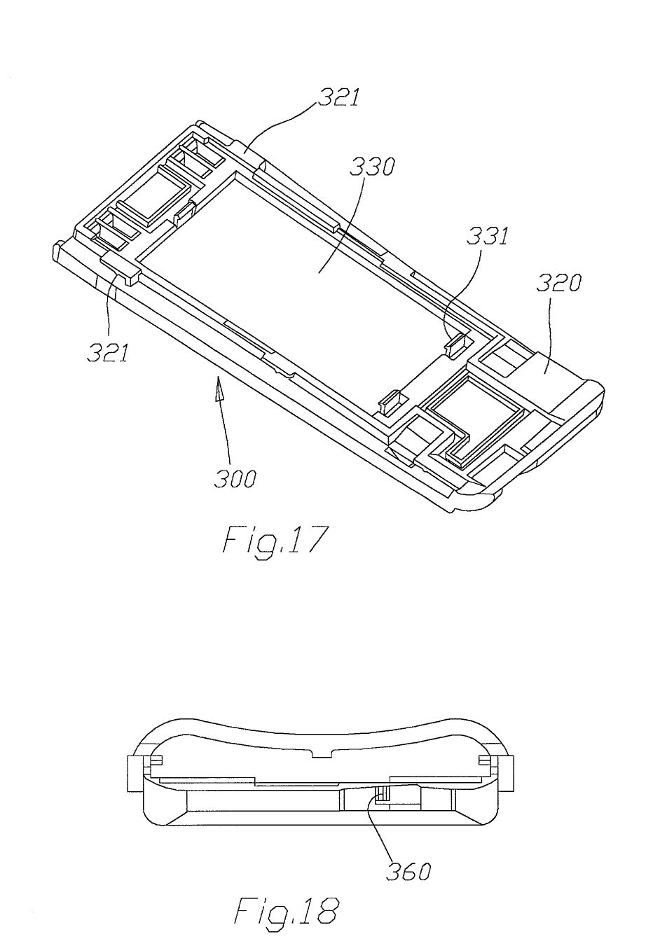

Referring to FIG. 16, a mobile phone of another preferred embodiment of the present invention provided with a rear casing is shown to be comprised of: a telephonic apparatus 100, a battery 200, and an interface card 300 connecting between the telephonic apparatus 100 and the battery 200. The interface card 300 is installed therein an electric circuit board 400 mounted with a plurality of SIM cards. The electric circuit board 400 is same as that stated above, it has a plurality of connectors 410 matching with a plurality of SIM cards (subscriber identification modules), these connectors 410 can be used to fixed the SIM cards; and the SIM card of each system can form a parallelly connected loop through a connecting point provided on the electric circuit board 400. Additionally, the electric circuit board 400 has thereon a soft bus line 420 to connect an extension card 500 which is inserted in the position where the SIM cards are originally located in the telephonic apparatus 100, so that the communication loop of the telephonic apparatus 100 can be communicated with the signals of the electric circuit board 400 having the SIM cards by means of the extension card 500 as an interface. The present invention is characterized by that: the aforesaid interface card 300 is provided on the front side 310 and the bottom side 320 thereof with slide rails 311 and slide grooves 321 respectively in cooperation and matching with the originally made battery 200 and the telephonic apparatus 100. Thereby, the bottom side 320 of the interface card 300 can slide into the telephonic apparatus 100 firstly to be fixed by a locking mechanism (to be described hereinafter), then the battery 200 slides in its proper way into the front side 310 of the interface card 300 and is positioned here by the button locking mode as was done in the factory.

As disclosed in FIG. 16, the telephonic apparatus 100 is provided at the area connecting with the battery 200 with slide rails 101, while the battery 200 is provided at the areas corresponding to the slide rails 101 with slide grooves 201; so that they can be combined with each other in sliding. The interface card 300 of the present invention is provided on the front side 310 at the areas corresponding to the slide grooves 201 of the battery 200 with the slide rails 311, and is provided on the bottom side 320 at the areas corresponding to the slide rails 101 of the telephonic apparatus 100 with the slide grooves 321 (referring simultaneously to FIG. 17 which is a perspective view showing the appearance of the interface card 300). The most important object of the present invention is to allow the interface card 300 to be received between the battery 200 and the telephonic apparatus 100 and to make combination of them through the matching sliding device, there is no need to make change for the telephonic apparatus 100 nor the structure or appearance of the telephonic apparatus 100.

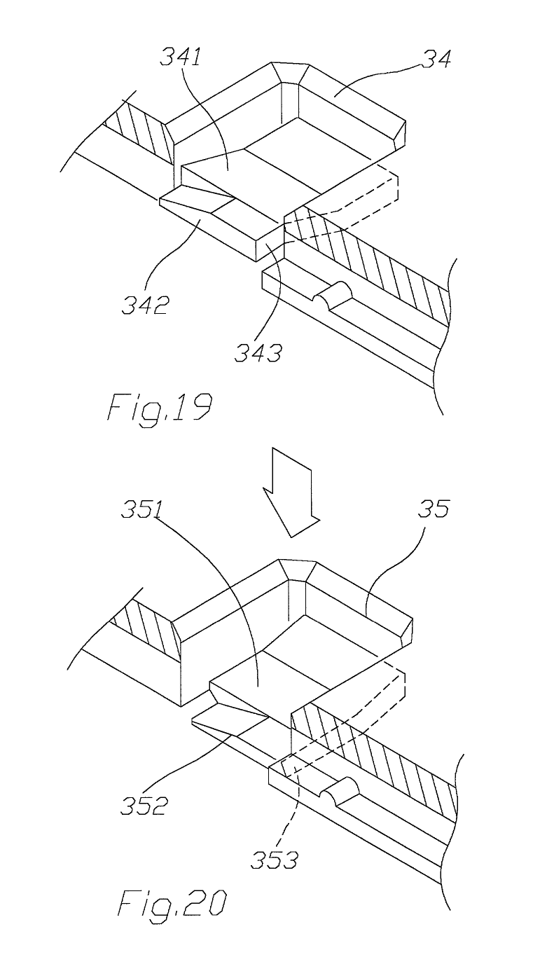

The interface card 300 disclosed in the above drawing is provided, in addition to the slide rails 311 and the slide grooves 321, with a manually moved switch 360 on the tailing end of the telephonic apparatus 100 (referring simultaneously to FIG. 18), the switch 360 can be selected and switched to any system for the telephonic apparatus 100 via connection of the circuit and the electric circuit board 400. Wherein, the interface card 300 is provided centrally thereof with a receiving groove or cavity 330 with an area slightly larger than that of the electric circuit board 400 for receiving the electric circuit board 400 having the SIM cards. It can be seen from the embodiments of FIG. 16 or 17 that, the cavity 330 is provided on an inner rim thereof with a plurality of upright hooks 331 to hook the electric circuit board 400. Besides, the interface card 300 is provided symmetrically at some areas near the tailing end of the telephonic apparatus 100 with two grooves 340, 350. And the grooves 340, 350 each is provided with a spring leaf 341 (351) and an inclined guide piece 342 (352) (at the circle area drawn in FIG. 16; please refer to FIG. 19 for the detailed structure of them). The inclined guide piece 342 or 352 is provided at the same level as that of the slide grooves 321, so that the interface card 300 can slide along the surfaces of the inclined guide piece 342 or 352 taking advantage of the slide rails 101 at two mutually opposite edges of the telephonic apparatus 100; finally, the interface card 300 can be locked and positioned against slipping off. It needs only to slightly press down the spring leaves 341, 351 such as is shown in FIG. 20, the slide rails 101 of the telephonic apparatus 100 can then be released from the fixing action to allow removing of the interface card 300 in the contrary direction.

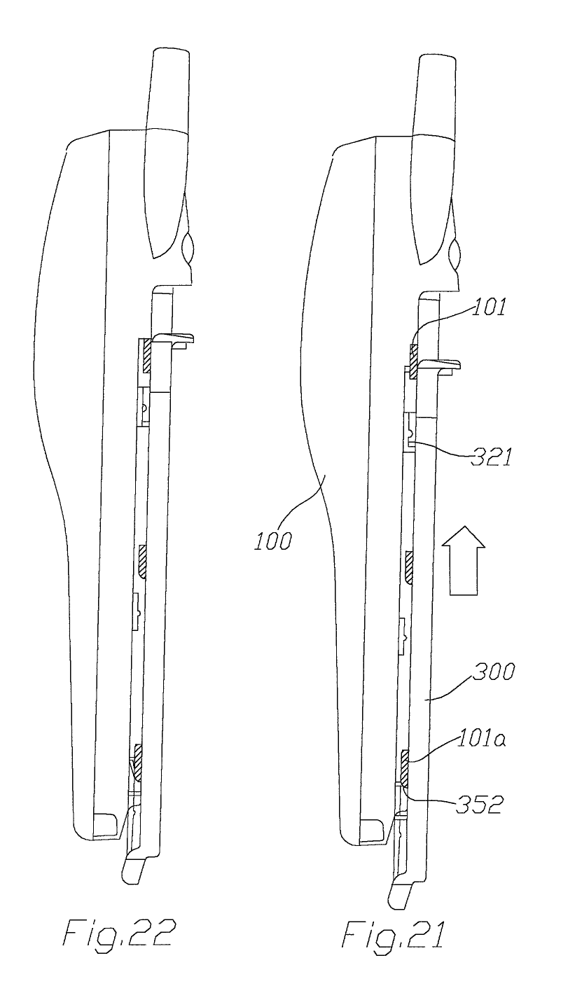

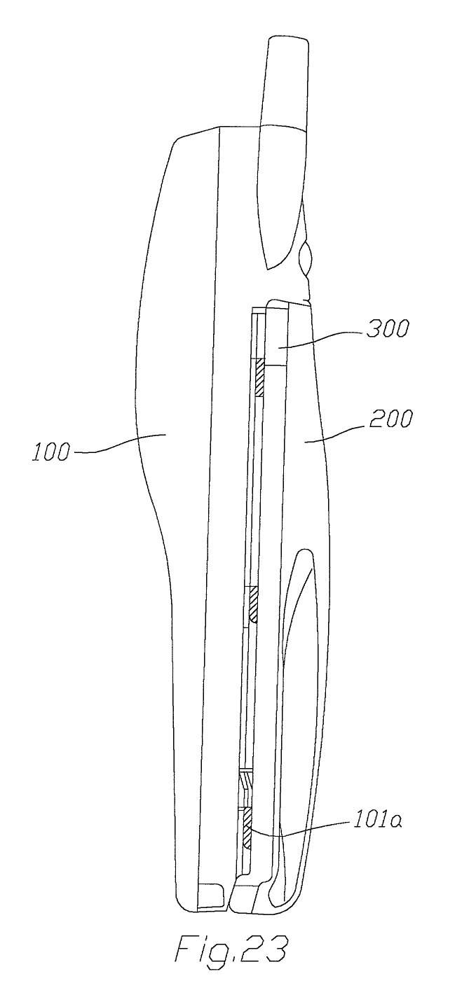

The detailed actions can be seen in FIGS. 21-23: when the interface card 300 is installed in the telephonic apparatus 100, it is moved forwardly by sliding along the slide rails 101 at two mutually opposite edges of the telephonic apparatus 100 taking advantage of the slide grooves 321, until the grooves 340, 350 with locking function approach the slide rail sections 101a at the end of the telephonic apparatus 100. Then it slides upwardly along the guiding slide rail sections 101a of the inclined guide pieces 342, 352, and it drops to the rear of the inclined guide pieces 342, 352 when it is raised to the top; there are abutting surfaces 342, 352 to prevent the guiding slide rail sections 101a from releasing in the contrary direction, thus locking of the interface card 300 is achieved.

The technical measures of the present invention has been disclosed as above in referring to a preferred embodiment thereof; but the present invention is not limited to this. It will be apparent to those skilled in this art that various modifications or changes can be made to the elements of the present invention without departing from the spirit, and scope of this invention. Accordingly, all such modifications and changes also fall within the scope of the appended claims and are intended to form part of this invention.

1. A mobile phone for multiple SIM cards comprising at least a telephonic apparatus, a battery, and a rear casing for covering said battery and connecting with said telephonic apparatus; said mobile phone is characterized by that: said rear casing has receiving capacity at least for loading of an electric circuit board, said electric circuit board has a plurality of connectors used for fixing a plurality of SIM cards (subscriber identification modules), said SIM cards each forms a parallelly connected loop connected through a connecting point provided on said electric circuit board; additionally, said electric circuit board has thereon a soft bus line to connect an extension card which is inserted in the position where said SIM cards are originally located in said telephonic apparatus, so that the communication loop of said telephonic apparatus is communicated with said electric circuit board by means of said extension card as an interface; said electric circuit board is installed thereon a manually moved switch on the contrary side to that loaded with said SIM cards, when said manually moved switch is switched to said loop of one of said SIM cards of any system, the state of combination of said telephonic apparatus is communicated in the close state with the one of said card loops of said system.

2. A mobile phone for multiple SIM cards as claimed in claim 1, wherein, said manually moved switch is exposed to the outside of said rear casing for manually moving.

3. A mobile phone for multiple SIM cards comprising a telephonic apparatus, a battery and an electric circuit board mounted with a plurality of SIM cards, said SIM cards each forms a parallelly connected loop connected through a connecting point provided on said electric circuit board; additionally, said electric circuit board has thereon a soft bus line to connect an extension card which is inserted in the position where said SIM cards are originally located in said telephonic apparatus, so that the communication loop of said telephonic apparatus is communicated with said electric circuit board by means of said extension card as an interface; and an interface card is connected between said telephonic apparatus and said battery, a manually moved switch is provided on said interface card to select a desired one of said telephone systems, said interface card is provided centrally thereof with a receiving groove to receive said electric circuit board having thereon said SIM cards, said manually moved switch is provided at an area near the tailing end of said telephonic apparatus

4. A mobile phone for multiple SIM cards as claimed in claim 3, wherein, said interface card is provided on the front side and the bottom side thereof with slide rails and slide grooves respectively in cooperation with said battery and said telephonic apparatus, thereby, said interface card is connected by sliding between said telephonic apparatus and said battery.

5. A mobile phone for multiple SIM cards as claimed in claim 3 or 4, wherein, said interface card is provided symmetrically at areas near the tailing end of said telephonic apparatus with two grooves, said grooves each is provided with a spring leaf and an inclined guide piece, so that said interface card is adapted to sliding along the surfaces of said inclined guide piece taking advantage of said slide rails at two mutually opposite edges of the telephonic apparatus; finally, said interface card is locked and positioned by dropping to a plurality of abutting surfaces to prevent said slide rails from releasing in a backward direction, thus locking of said interface card is achieved.

6. A mobile phone for multiple SIM cards as claimed in claim 3 or 4, wherein, said receiving groove provided centrally of said interface card is a cavity which is provided on an inner rim thereof with a plurality of upright hooks to hook said electric circuit board.
